(19) United States
(12) Patent Application Publication
(10) Pub. No.: US 2025/0183961 A1
(43) Pub. Date: Jun. 5, 2025

(54) PORT GROUPS FOR REPORTING MULTIPLE TRANSMISSION RECEPTION POINT COHERENT JOINT TRANSMISSION CHANNEL STATE INFORMATION

(71) Applicant: QUALCOMM Incorporated, San Diego, CA (US)

(72) Inventors: Min HUANG, Beijing (CN); Jing DAI, Beijing (CN); Chenxi HAO, Beijing (CN); Liangming WU, Beijing (CN); Chao WEI, Beijing (CN); Hao XU, Beijing (CN)

(21) Appl. No.: 18/841,512

(22) PCT Filed: Apr. 29, 2022
(86) PCT No.: PCT/CN2022/090569

§ 371 Date: Aug. 26, 2024

(51) Int. Cl. H04B 7/06; H04B 7/0456; H04W 24/10

(52) U.S. Cl. CPC H04B 7/0626; H04B 7/0456; H04W 24/10

(57) ABSTRACT

Various aspects of the present disclosure generally relate to wireless communication. In some aspects, a user equipment (UE) may receive a channel state information (CSI) reporting configuration indicating a plurality of port groups, each port group of the plurality of port groups comprising one or more ports of a plurality of ports associated with a multi-port channel state information-reference signal (CSI-RS) resource for reporting multiple transmission reception point (mTRP) coherent joint transmission (CJT) CSI, and indicating a plurality of codebook subset restrictions (CBSRs) associated with the multi-port CSI-RS resource, each of the plurality of CBSRs associated with a port group of the plurality of port groups. The UE may receive a multi-port CSI-RS communication. The UE may transmit an mTRP CJT CSI report based at least in part on the CSI reporting configuration and the multi-port CSI-RS communication. Numerous other aspects are described.

### FIELD OF THE DISCLOSURE

Aspects of the present disclosure generally relate to wireless communication and to techniques and apparatuses for port groups for reporting multiple transmission reception point coherent joint transmission channel state information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to receive a channel state information (CSI) reporting configuration indicating a plurality of port groups, each port group of the plurality of port groups comprising one or more ports of a plurality of ports associated with a multi-port channel state information-reference signal (CSI-RS) resource for reporting multiple transmission reception point (mTRP) coherent joint transmission (CJT) CSI, and indicating a plurality of codebook subset restrictions (CBSRs) associated with the multi-port CSI-RS resource, each CBSR of the plurality of CBSRs associated with a port group of the plurality of port groups. The one or more processors may be configured to receive a multi-port CSI-RS communication. The one or more processors may be configured to transmit an mTRP CJT CSI report based at least in part on the CSI reporting configuration and the multi-port CSI-RS communication.

Some aspects described herein relate to a network node for wireless communication. The network node may include a memory and one or more processors coupled to the memory. The one or more processors may be configured to transmit a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of CBSRs associated with the multi-port CSI-RS resources, each CBSR of the plurality of CBSRs associated with a port group of the plurality of port groups. The one or more processors may be configured to transmit a multi-port CSI-RS communication. The one or more processors may be configured to receive an mTRP CJT CSI report based at least in part on the CSI reporting configuration and the multi-port CSI-RS communication.

Some aspects described herein relate to a method of wireless communication performed by a UE. The method may include receiving a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of CBSRs associated with the multi-port CSI-RS resource, each CBSR of the plurality of CBSRs associated with a port group of the plurality of port groups. The method may include receiving a multi-port CSI-RS communication. The method may include transmitting an mTRP CJT CSI report based at least in part on the CSI reporting configuration and the multi-port CSI-RS communication.

Some aspects described herein relate to a method of wireless communication performed by a network node. The method may include transmitting a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of CBSRs associated with the multi-port CSI-RS resources, each CBSR of the plurality of CBSRs associated with a port group of the plurality of port groups. The method may include transmitting a multi-port CSI-RS communication. The method may include receiving an mTRP CJT CSI report based at least in part on the CSI reporting configuration and the multi-port CSI-RS communication.

Some aspects described herein relate to a non-transitory computer-readable medium that stores a set of instructions for wireless communication by a UE. The set of instructions, when executed by one or more processors of the UE, may cause the UE to receive a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of CBSRs associated with the multi-port CSI-RS resource, each CBSR of the plurality of CBSRs associated with a port group of the plurality of port groups. The set of instructions, when executed by one or more processors of the UE, may cause the UE to receive a multi-port CSI-RS communication. The set of instructions, when executed by one or more processors of the UE, may cause the UE to transmit an mTRP CJT CSI report based at least in part on the CSI reporting configuration and the multi-port CSI-RS communication.

Some aspects described herein relate to a non-transitory computer-readable medium that stores a set of instructions for wireless communication by a network node. The set of instructions, when executed by one or more processors of the network node, may cause the network node to transmit a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of CBSRs associated with the multi-port CSI-RS resources, each CBSR of the plurality of CBSRs associated with a port group of the plurality of port groups. The set of instructions, when executed by one or more processors of the network node, may cause the network node to transmit a multi-port CSI-RS communication. The set of instructions, when executed by one or more processors of the network node, may cause the network node to receive an mTRP CJT CSI report based at least in part on the CSI reporting configuration and the multi-port CSI-RS communication.

Some aspects described herein relate to an apparatus for wireless communication. The apparatus may include means for receiving a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of CBSRs associated with the multi-port CSI-RS resource, each CBSR of the plurality of CBSRs associated with a port group of the plurality of port groups. The apparatus may include means for receiving a multi-port CSI-RS communication. The apparatus may include means for transmitting an mTRP CJT CSI report based at least in part on the CSI reporting configuration and the multi-port CSI-RS communication.

Some aspects described herein relate to an apparatus for wireless communication. The apparatus may include means for transmitting a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of CBSRs associated with the multi-port CSI-RS resources, each CBSR of the plurality of CBSRs associated with a port group of the plurality of port groups. The apparatus may include means for transmitting a multi-port CSI-RS communication. The apparatus may include means for receiving an mTRP CJT CSI report based at least in part on the CSI reporting configuration and the multi-port CSI-RS communication.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of open radio access network architecture, in accordance with the present disclosure.

FIG. 4 is a diagram illustrating an example of multiple transmission reception point (mTRP) communications, in accordance with the present disclosure.

FIG. 5 is a diagram illustrating an example associated with port groups for reporting mTRP coherent joint transmission (CJT) channel state information (CSI), in accordance with the present disclosure.

FIGS. 6 and 7 are diagrams illustrating example processes associated with port groups for reporting mTRP CJT CSI, in accordance with the present disclosure.

FIGS. 8 and 9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

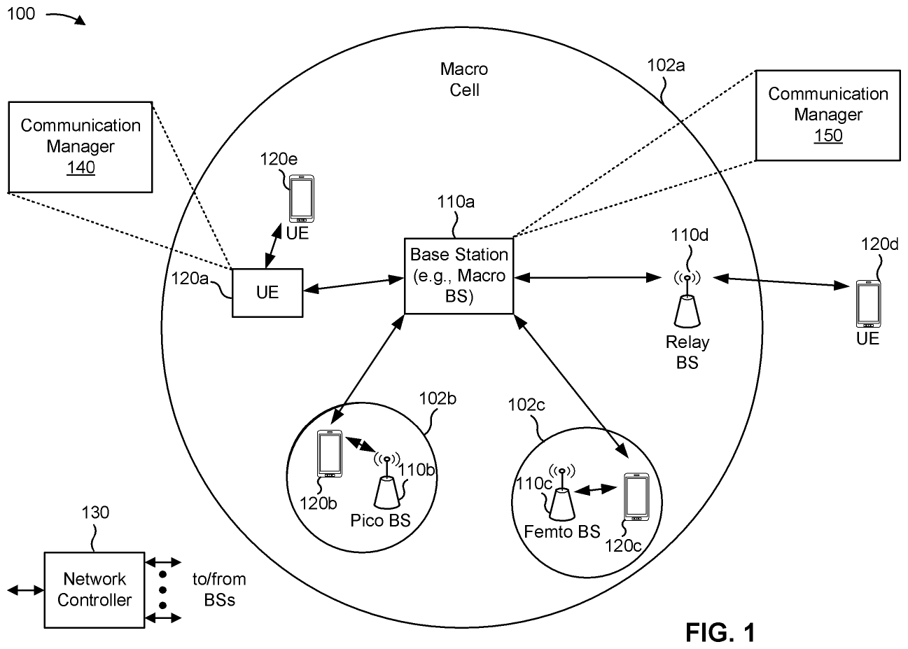

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described herein, a network node, which may be referred to as a “node,” a “network node,” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some aspects, the UE 120 may include a communication manager 140. As described in more detail elsewhere herein, the communication manager 140 may receive a channel state information (CSI) reporting configuration indicating a plurality of port groups, each port group of the plurality of port groups comprising one or more ports of a plurality of ports associated with a multi-port channel state information-reference signal (CSI-RS) resource for reporting multiple transmission reception point (mTRP) coherent joint transmission (CJT) CSI, and indicating a plurality of codebook subset restrictions (CBSRs) associated with the multi-port CSI-RS resource, each CBSR of the plurality of CBSRs associated with a port group of the plurality of port groups; receive a multi-port CSI-RS communication; and transmit an mTRP CJT CSI report based at least in part on the CSI reporting configuration and the multi-port CSI-RS communication. Additionally, or alternatively, the communication manager 140 may perform one or more other operations described herein.

In some aspects, the network node may include a communication manager 150. As described in more detail elsewhere herein, the communication manager 150 may transmit a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of CBSRs associated with the multi-port CSI-RS resource, each CBSR of the plurality of CBSRs associated with a port group of the plurality of port groups; transmit a multi-port CSI-RS communication; and receive an mTRP CJT CSI report based at least in part on the CSI reporting configuration and the multi-port CSI-RS communication. Additionally, or alternatively, the communication manager 150 may perform one or more other operations described herein.

As indicated above, FIG. 1 is provided as an example. Other examples may differ from what is described with regard to FIG. 1.

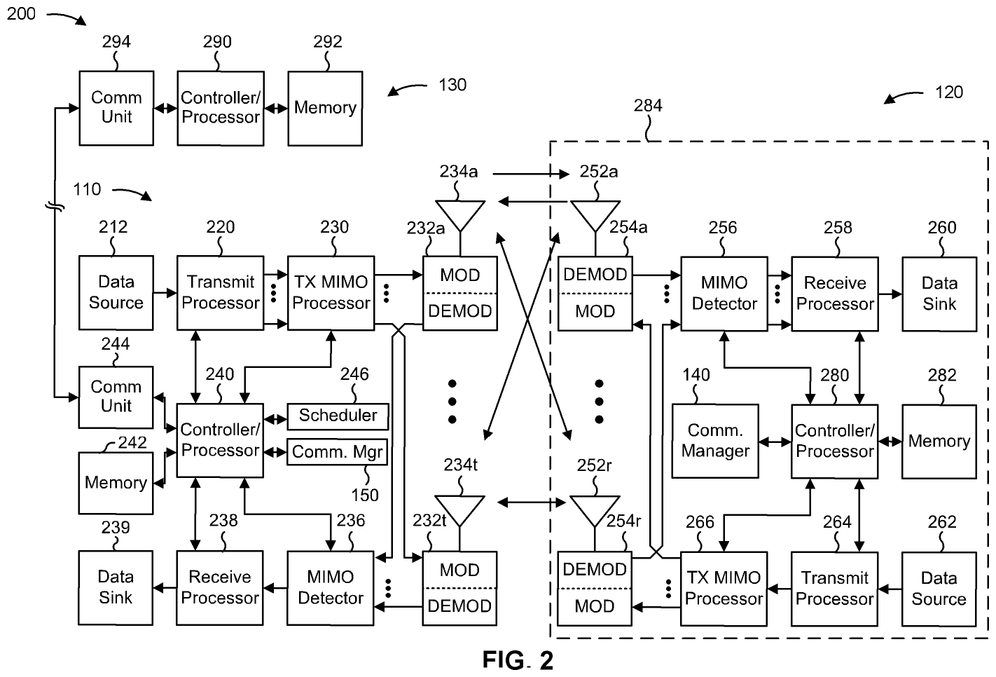

FIG. 2 is a diagram illustrating an example 200 of a base station 110 in communication with a UE 120 in a wireless network 100, in accordance with the present disclosure. The base station 110 may be equipped with a set of antennas 234a through 234t, such as T′ antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

In some aspects, the term “base station” (e.g., the base station 110), “network node,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) radio access network (RAN) Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

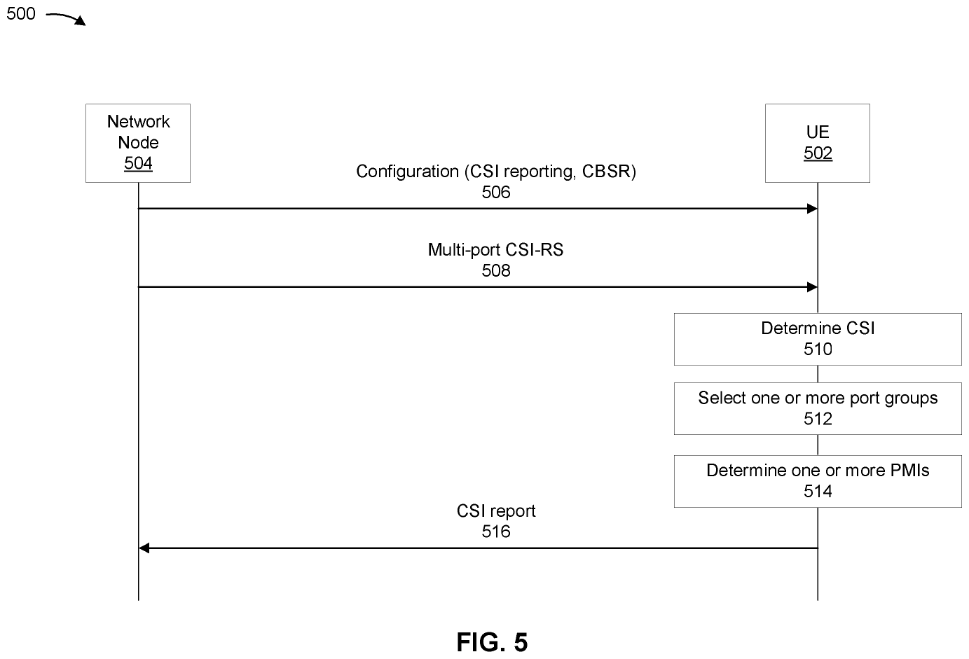

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

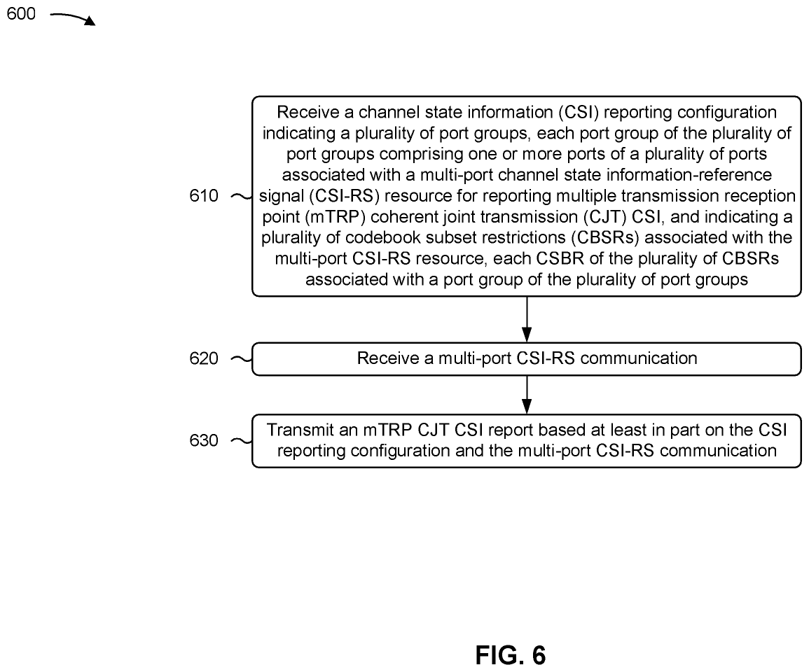

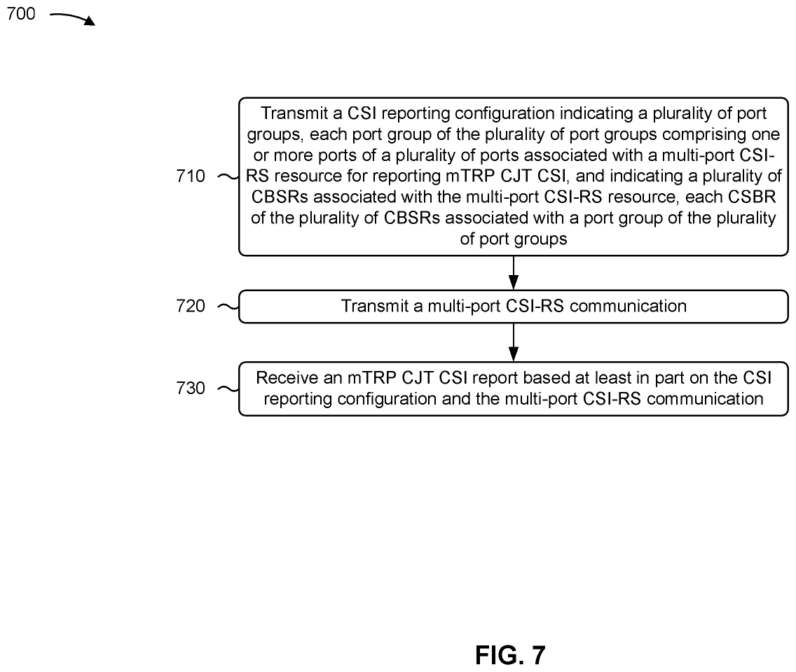

The controller/processor 240 of the base station 110, the controller/processor 280 of the UE 120, and/or any other component(s) of FIG. 2 may perform one or more techniques associated with port groups for reporting mTRP CJT CSI, as described in more detail elsewhere herein. In some aspects, the network node described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the (UE includes means for receiving a CSI reporting configuration indicating a plurality of port groups, each port group of the plurality of port groups comprising one or more ports of a plurality of ports associated with a multi-port CSI-RS resource for reporting mTRP CJT CSI, and a plurality of CBSRs associated with the multi-port CSI-RS resource, each CBSR of the plurality of CBSRs associated with a port group of the plurality of port groups (e.g., using antenna 252, modem 254, MIMO detector 256, receive processor 258, controller/processor 280, memory 282, or the like); means for receiving a multi-port CSI-RS communication (e.g., using antenna 252, modem 254, MIMO detector 256, receive processor 258, controller/processor 280, memory 282, or the like); and/or means for transmitting an mTRP CJT CSI report based at least in part on the CSI reporting configuration and the multi-port CSI-RS communication (e.g., using controller/processor 280, transmit processor 264, TX MIMO processor 266, modem 254, antenna 252, memory 282, or the like). The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting CSI reporting configuration indicating a plurality of port groups, each port group of the plurality of port groups comprising one or more ports of a plurality of ports associated with a multi-port CSI-RS resource for reporting mTRP CJT CSI, and indicating a plurality of CBSRs associated with the multi-port CSI-RS resource, each CBSR of the plurality of CBSRs associated with a port group of the plurality of port groups (e.g., using controller/processor 240, transmit processor 220, TX MIMO processor 230, modem 232, antenna 234, memory 242, or the like); means for transmitting a multi-port CSI-RS communication (e.g., using controller/processor 240, transmit processor 220, TX MIMO processor 230, modem 232, antenna 234, memory 242, or the like); and/or means for receiving an mTRP CJT CSI report based at least in part on the CSI reporting configuration and the multi-port CSI-RS communication (e.g., using antenna 234, modem 232, MIMO detector 236, receive processor 238, controller/processor 240, memory 242, or the like). In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

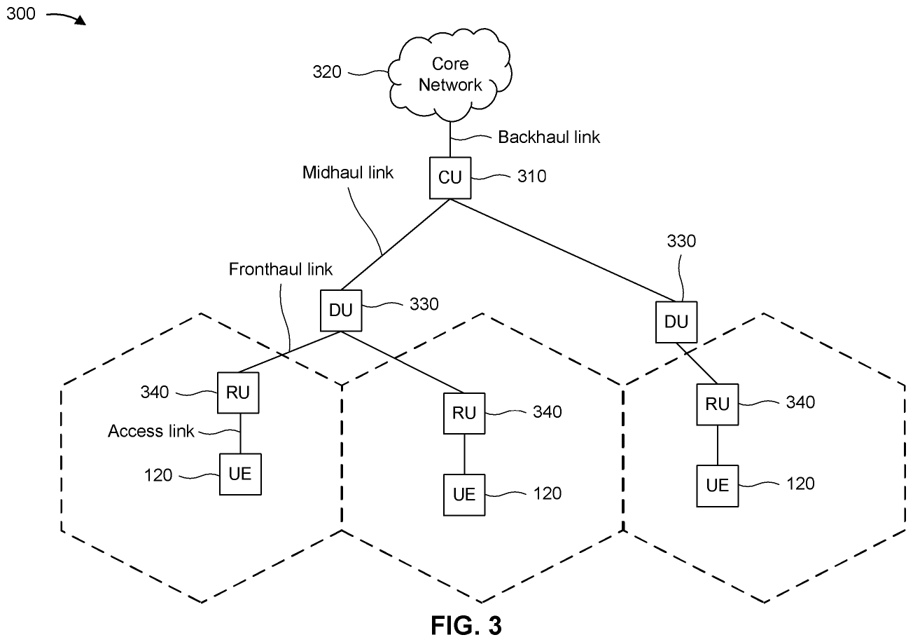

FIG. 3 is a diagram illustrating an example 300 of an open radio access network (O-RAN) architecture, in accordance with the present disclosure. As shown in FIG. 3, the O-RAN architecture may include a centralized unit (CU) 310 that communicates with a core network 320 via a backhaul link. Furthermore, the CU 310 may communicate with one or more distributed units (DUs) 330 via respective midhaul links. The DUs 330 may each communicate with one or more radio units (RUs) 340 via respective fronthaul links, and the RUs 340 may each communicate with respective UEs 120 via radio frequency (RF) access links. The DUs 330 and the RUs 340 may also be referred to as O-RAN DUS (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

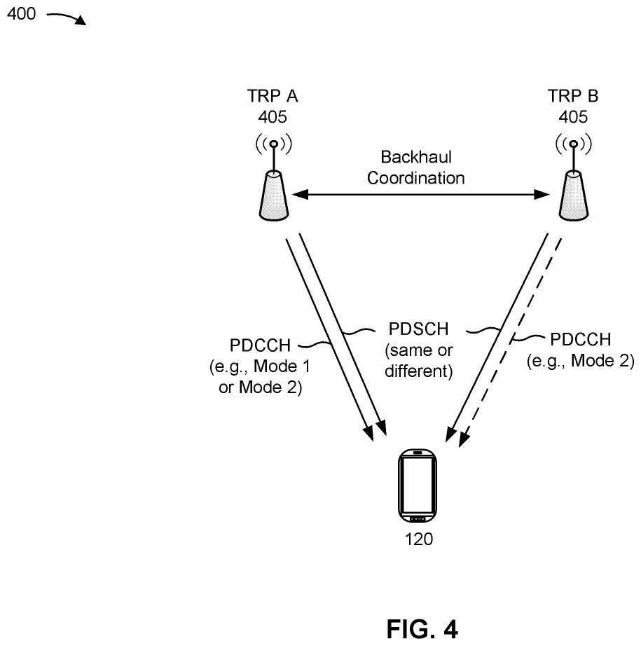

FIG. 4 is a diagram illustrating an example 400 of mTRP communication (sometimes referred to as multi-panel communication), in accordance with the present disclosure. As shown in FIG. 4, multiple TRPs 405 may communicate with the same UE 120. A network node may include multiple TRPs 405, or multiple TRPs 405 may be distributed across multiple network nodes.

The multiple TRPs 405 (shown as TRP A and TRP B) may communicate with the same UE 120 in a coordinated manner (e.g., using coordinated multipoint transmissions) to improve reliability and/or increase throughput. The TRPs 405 may coordinate such communications via an interface between the TRPs 405 (e.g., a backhaul interface and/or an access node controller). The interface may have a smaller delay and/or higher capacity when the TRPs 405 are co-located at the same network node (e.g., when the TRPs 405 are different antenna arrays or panels of the same network node), and may have a larger delay and/or lower capacity (as compared to co-location) when the TRPs 405 are located at different network nodes. The different TRPs 405 may communicate with the UE 120 using different quasi co-location (QCL) relationships (e.g., different transmission configuration indicator (TCI) states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 405 (e.g., TRP A and TRP B) may transmit communications to the UE 120 on the same PDSCH. For example, a communication may be transmitted using a single codeword with different spatial layers for different TRPs 405 (e.g., where one codeword maps to a first set of layers transmitted by a first TRP 405 and maps to a second set of layers transmitted by a second TRP 405). As another example, a communication may be transmitted using multiple codewords, where different codewords are transmitted by different TRPs 405 (e.g., using different sets of layers). In either case, different TRPs 405 may use different QCL relationships (e.g., different TCI states) for different DMRS ports corresponding to different layers. For example, a first TRP 405 may use a first QCL relationship or a first TCI state for a first set of DMRS ports corresponding to a first set of layers, and a second TRP 405 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 405, and a second PDCCH may schedule a second codeword to be transmitted by a second TRP 405. Furthermore, first DCI (e.g., transmitted by the first TRP 405) may schedule a first PDSCH communication associated with a first set of DMRS ports with a first QCL relationship (e.g., indicated by a first TCI state) for the first TRP 405, and second DCI (e.g., transmitted by the second TRP 405) may schedule a second PDSCH communication associated with a second set of DMRS ports with a second QCL relationship (e.g., indicated by a second TCI state) for the second TRP 405. In this case, DCI (e.g., having DCI format 1_0 or DCI format 1_1) may indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state).

In some cases, a codebook for mTRP CJT can be configured to support larger numbers of ports for low-frequency bands for co-located and/or distributed TRPs. However, transmissions from the multiple TRPs, in certain directions, can result in interference. Accordingly, a codebook subset restriction (CBSR) can be used to reduce and/or avoid interference in certain directions. CBSR of single-TRP eType-II codebook transmissions is supported by some wireless communication networks. In the single TRP case, for example, a network node can configure a bit sequence B=B₁B₂ to a UE, where B₁ represents which spatial basis group (oversampling offset) are selected, and B₂ represents the power restriction of each spatial basis in the selected spatial basis. In accordance with the CBSR, the average coefficient amplitude of beam i+pL, which corresponds to the spatial basis indexed by (k, x1, x2) may have a maximum value given by the Table 1, below.

TABLE 1

| | Maximum Average |
|---|---|
| Bit | Coefficient Amplitude |
| b₂^{(k, 2(N}^{₁}^{x}^{₂}^{+x}^{₁}⁾⁺¹⁾ | γ_{i+pL} |
| 00 | 0 |
| 01 | \sqrt{¼} |
| 10 | \sqrt{½} |
| 11 | 1 |

In mTRP non-CJT, two CBSRs can separately configured for a pair of CSI-RS resources from two channel management resource (CMR) groups. For example, one CBSR can be associated with the TRP from CMR group 1, while the other CBSR is associated with the TRP from CMR group 2. However, in mTRP CJT scenarios, the CSI-RS for each TRP can be configured according to port groups within one CSI-RS resource. In this case, the non-CJT CBSR cannot take into account the port groups within one CSI-RS resource. Additionally, if a CBSR for CJT is configured to be applied to the port groups in the mTRP CJT scenarios, the CBSR can be ineffective for a UE that may communicate in a single-TRP configuration and requiring signaling a CBSR for both possible scenarios would result in unnecessary signaling overhead.

Some aspects of the techniques and apparatuses described herein may provide for multiple port groups corresponding to a multi-port CSI-RS resource for reporting mTRP CJT CSI. For example, a network node may configure a UE with the multiple port groups and configure CBSRs associated with the multi-port CSI-RS. For example, in some aspects, the CBSRs may be configured according to a two-part configuration. In this way, a single TRP or an mTRP configuration may be selectable.

In some aspects, for example, a first part of the configuration may configure an individual CBSR for each port group. This configuration may be used when the UE selects the ports from only one port group in a CSI report. In a second part of the configuration, a combined CBSR may be configured for one or more port group combinations. This configuration may be used when the UE simultaneously selects the ports from more than one port groups in a CSI report. Each combined CBSR may be composed of multiple CBSRs, each corresponding to one port group within the port group combination. In some aspects, to reduce the signaling overhead, the CBSR in the CBSR combination may be indicated using a differential value with respect to the corresponding individual CBSR indicated in the first part of the configuration. In some aspects, a one-part configuration may be configured and used only for mTRP. The CBSR configuration may include at least one port group combination, in which the indices of port groups and CBSR of each port group are indicated.

In some aspects, the UE may receive a multi-port CSI-RS from a network node and may obtain CSI measurements associated with the CSI-RS. The UE may select one or more port groups (each of which may correspond to a TRP) and determine an mTRP CJT precoding matrix indicator (PMI) for each of the selected port groups. If one port group is selected, the PMI should satisfy the individual CBSR of the selected port group. If multiple port groups are selected, the PMI of each port group should satisfy the combined CBSR of the selected port group combination. In some aspects, when the number of multi-TRP combinations (port group combinations) is large, the differential CBSR may greatly reduce signaling overhead.

As indicated above, FIG. 4 is provided as an example. Other examples may differ from what is described with respect to FIG. 4.

FIG. 5 is a diagram illustrating an example 500 associated with port groups for reporting mTRP CJT CSI, in accordance with the present disclosure. As shown, example 500 may include a UE 502 and a network node 504 in communication with one another. The network node 504 may include any number of TRPs. The TRPs may be co-located and/or distributed.

As shown by reference number 506, the network node 504 may transmit, and the UE 502 may receive, a configuration. In some aspects, the configuration may include a CSI reporting configuration indicating a plurality of port groups, each port group of the plurality of port groups comprising one or more ports of a plurality of ports associated with mTRP multi-port CSI-RS resource for reporting mTRP CJT CSI, and a plurality of codebook subset restrictions (CBSRs) associated with the multi-port CSI-RS resource, each CBSR of the plurality of CBSRs associated with a port group of the plurality of port groups.

In some aspects, the CSI reporting configuration may be associated with a first selectable option and a second selectable option. The first selectable option may correspond to a single-TRP configuration and the second selectable option may correspond to an mTRP configuration. The first selectable option may indicate a plurality of CBSRs, where each CBSR of the plurality of CBSRs may be associated with one port group of the plurality of port groups.

In some aspects, if a spatial basis (beam) of a TRP has restricted transmission power, then the transmission power will be equal or decreased when a spatial basis (beam) of another TRP has the same direction. Thus, in some aspects, a CBSR of the plurality of CBSRs comprises a Type II codebook CBSR (e.g., a legacy eType-II codebook CBSR). The CBSR may include K restrictions. For example, the CBSR may include at least one restriction. The at least one restriction may include an indication of a spatial basis group containing one or more spatial bases having shared oversampling offsets and an indication of a maximum transmission power of each spatial basis of the spatial basis group. For example, each restriction may include an indication of a spatial basis group containing the spatial bases with the same oversampling offsets (O_{n,k,l}, O_{n,k,2}), k=1˜K, n=1˜N. Here, N is the number of port groups (e.g., the number of TRPs). Each restriction also may include an indication of maximum transmission power of each (the lth) spatial basis of the indicated spatial basis group, denoted as Y_{n,k,l}, l=1˜L. Here, L is the number of spatial bases.

In some aspects, the second selectable option may indicate a combined CBSR associated with a combination of two or more port groups of the plurality of port groups. The combined CBSR may include a plurality of CBSRs, where each CBSR of the plurality of CBSRs is associated with one port group of the two or more port groups. The combined CBSR may include a plurality of indices associated with the two or more port groups and a plurality of differential transmission power restriction values corresponding to a plurality of spatial bases of each of the two or more port groups. For example, the second selectable option may indicate combined CBSRs for a plurality of (M) port group combinations.

For one (the mth) port group combination, the CBSR may include the indices of multiple port groups, denoted as [n_{m,1}, n_{m,2}, . . . , nₘ, Nₘ], where Nₘ is the number of port groups in the mth port group combination. The CBSR also may include a differential value indicating a transmission power restriction for each spatial basis of the port group (relative to a certain restriction of this port group) in this port group combination, denoted as α_{m,n,k,l}. In this way, the actual maximum transmission power of one spatial basis in the mth port group combination is equal to γ_{n,k,l}×α_{m,n,k,l}.

In some aspects, the plurality of indices may be indicated using a bitmap. For example, for each port group combination, a size-N bitmap may express the selection of port groups. In another example, [log₂ N] bits may express Nₘ, and

$$⌈ {log}_{2} ( \begin{matrix}N \\ {N}_{m}\end{matrix} ) ⌉$$

bits may express the selection Nₘ port groups out of a total of N candidate port groups. To reduce signaling overhead, α_{m,n,k,l} may be quantified with fewer bits than γ_{n,k,l}. For example, γ_{n,k,l} may be quantized by 2 bits, and α_{m,n,k,l} may be quantized by 1 bit, as shown in Table 2, below.

TABLE 2

| expression bits | γ_{n, k, l} |
|---|---|
| 00 | 0 |
| 01 | \sqrt{¼} |
| 10 | \sqrt{½} |
| 11 | 1 |

If α_{m,n,k,l} is quantized with 1 bit, the bitmap may be as shown in Table 3, below.

TABLE 3

| expression bit | α_{m, n, k, l} |
|---|---|
| 0 | \sqrt{½} |
| 1 | 1 |

If α_{m,n,k,l} is quantized with 2 bits, the bitmap may be as shown in Table 4, below.

TABLE 4

| expression bit | α_{m, n, k, l} |
|---|---|
| 00 | \sqrt{¼} |
| 01 | \sqrt{⅓} |
| 10 | \sqrt{½} |
| 11 | 1 |

In some aspects, the CSI reporting configuration may include an indication of a plurality of CBSRs, where each CBSR of the plurality of CBSRs is associated with one port group of the plurality of port groups and a differential value indicating a combined CBSR associated with a combination of two or more port groups of the plurality of port groups. In some aspects, the CSI reporting configuration may be associated with an mTRP configuration, and the CSI reporting configuration may include an indication of at least one port group combination. The at least one CBSR indication may include an indication of a plurality of port group indices, each index of the plurality of port group indices corresponding to a port group of the at least one port group combination and an indication of a plurality of CBSRs, where each CBSR corresponds to a port group of the at least one port group combination.

In an example, a total of N=4 port groups may be in the configured CSI-RS resources. A total of M=2 port group combinations may be configured. In a first part of the configuration, each port group may be configured with K=2 CBSR restrictions. The values of {γ_{n,k,l}} port group may be configured. In a second part of the configuration, a port group combination 1 may contain port group 1 and 2, and a port group combination 2 may contain port groups 1, 2, 3, and 4. The values of {α_{m,n,k,l}} for each port group combination may be configured. In this way, the actual CBSR for the port group combination (mTRP CJT) may be indicated as follows: for port group combination 1 (TRP combination 1):
port group 1 (TRP 1): γ_{1,k,l}×α1,1,kl, port group 2 (TRP 2): γ_{2,k,l}×α_{1,2,k,l}, and for port group combination 2 (TRP combination 2):
port group 1 (TRP 1): Y_{1,k,l}×α_{2,1,k,l}, port group 2 (TRP 2): γ_{2,k,l}×α_{2,2,k,l}, port group 3 (TRP 3): γ_{3,k,l}×α_{2,3,k,l}, and port group 4 (TRP 4): γ_{4,k,l}×α_{2,4,k,l}. For the spatial bases whose beam directions are restricted, α_{m,n,k,l} is smaller than 1 (e.g., \sqrt{1/2} for two-TRP CJT, \sqrt{1/3} for three-TRP CJT, \sqrt{1/4} for four-TRP CJT). For the spatial bases whose beam directions are not restricted, α_{m,n,k,l}=1.

As shown by reference number 508, the network node 504 may transmit, and the UE 502 may receive, a multi-port CSI-RS communication. As shown by reference number 510, the UE 502 may determine CSI based at least in part on the multi-port CSI-RS communication. As shown by reference number 512, the UE 502 may select one or more port groups of the plurality of port groups.

As shown by reference number 514, the UE 502 may determine one or more mTRP CJT PMIs associated with the one or more port groups based on the plurality of CBSRs. In some aspects, for example, the UE 502 may select only one port group, and an mTRP CJT PMI, of the one or more mTRP CJT PMIs, associated with the only one port group may satisfy a CBSR associated with the only one port group. In some aspects, the UE 502 may select a plurality of port groups, and an mTRP CJT PMI, of the one or more mTRP CJT PMIs, associated with a port group of the plurality of port groups may satisfy a combined CBSR associated with a combination of port groups that includes the port group.

As shown by reference number 516, the UE 502 may transmit, and the network node 504 may receive, an mTRP CJT CSI report based at least in part on the CSI reporting configuration and the multi-port CSI-RS communication.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 502) performs operations associated with port groups for reporting multiple transmission reception point coherent joint transmission channel state information.

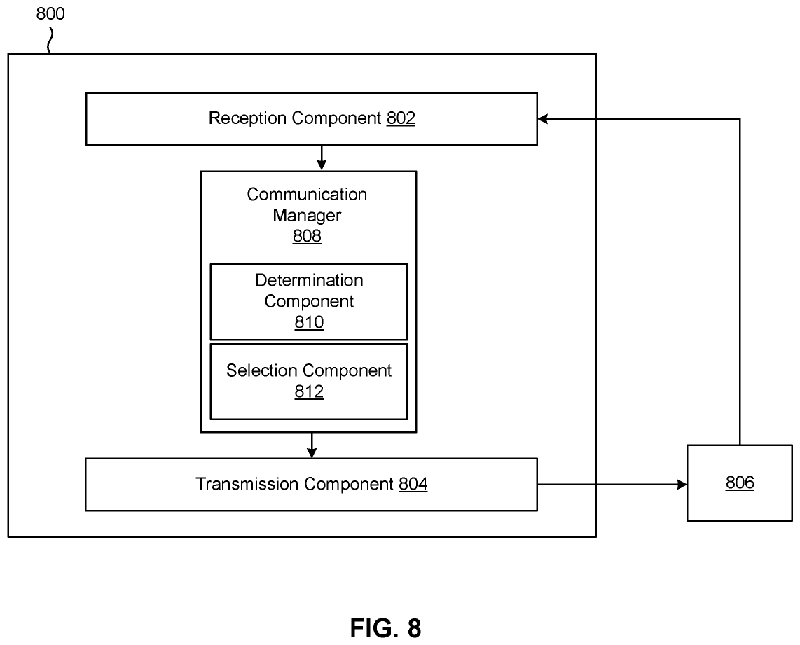

As shown in FIG. 6, in some aspects, process 600 may include receiving a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of codebook subset restrictions (CBSRs) associated with the multi-port CSI-RS resource, each CBSR of the plurality of CBSRs associated with a port group of the plurality of port groups (block 610). For example, the UE (e.g., using communication manager 808 and/or reception component 802, depicted in FIG. 8) may receive a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of codebook subset restrictions (CBSRs) associated with the multi-port CSI-RS resource, each CBSR of the plurality of CBSRs associated with a port group of the plurality of port groups, as described above, for example, with reference to FIG. 5.

As further shown in FIG. 6, in some aspects, process 600 may include receiving a multi-port CSI-RS communication (block 620). For example, the UE (e.g., using communication manager 808 and/or reception component 802, depicted in FIG. 8) may receive a multi-port CSI-RS communication, as described above, for example, with reference to FIG. 5.

As further shown in FIG. 6, in some aspects, process 600 may include transmitting an mTRP CJT CSI report based at least in part on the CSI reporting configuration and the multi-port CSI-RS communication (block 630). For example, the UE (e.g., using communication manager 808 and/or transmission component 804, depicted in FIG. 8) may transmit an mTRP CJT CSI report based at least in part on the CSI reporting configuration and the multi-port CSI-RS communication, as described above, for example, with reference to FIG. 5.

Process 600 may include additional aspects, such as any single aspect or any combination of aspects described below and/or in connection with one or more other processes described elsewhere herein.

In a first aspect, process 600 includes determining channel state information based at least in part on the multi-port CSI-RS communication, selecting one or more port groups of the plurality of port groups, and determining one or more mTRP CJT PMIs associated with the one or more port groups based on the plurality of CBSRs. In a second aspect, alone or in combination with the first aspect, selecting one or more port groups comprises selecting only one port group, and wherein an mTRP CJT PMI, of the one or more mTRP CJT PMIs, associated with the only one port group satisfies a CBSR, of the plurality of CBSRs, associated with the only one port group.

In a third aspect, alone or in combination with one or more of the first and second aspects, selecting one or more port groups comprises selecting a plurality of port groups, and wherein an mTRP CJT PMI, of the one or more mTRP CJT PMIs, associated with a port group of the plurality of port groups satisfies a combined codebook subset restriction associated with a combination of port groups that includes the port group. In a fourth aspect, alone or in combination with one or more of the first through third aspects, each port group of the plurality of port groups corresponds to one TRP of a plurality of TRPs associated with multi-port CSI-RS communication.

In a fifth aspect, alone or in combination with one or more of the first through fourth aspects, the plurality of CBSRs are associated with a first selectable option and a second selectable option, the first selectable option corresponding to a single-TRP configuration and the second selectable option corresponding to an mTRP configuration.

In a sixth aspect, alone or in combination with the fifth aspect, the first selectable option indicates a plurality of CBSRs, wherein each CBSR of the plurality of CBSRs is associated with one port group of the plurality of port groups. In a seventhaspect, alone or in combination with the sixth aspect, a CBSR of the plurality of CBSRs comprises a Type II codebook CBSR comprising at least one restriction, wherein the at least one restriction comprises an indication of a spatial basis group containing one or more spatial bases having shared oversampling offsets, and an indication of a maximum transmission power of each spatial basis of the spatial basis group.

In an eighth aspect, alone or in combination with one or more of the fifth through seventh aspects, process 600 includes selecting only one port group of the plurality of port groups for reporting, wherein the first selectable option is selected based at least in part on the selection of the only one port group. In a ninth aspect, alone or in combination with one or more of the fifth through eighth aspects, the second selectable option indicates a combined CBSR associated with a combination of two or more port groups of the plurality of port groups.

In a tenth aspect, alone or in combination with the ninth aspect, the combined CBSR comprises the plurality of CBSRs, wherein each CBSR of the plurality of CBSRs is associated with one port group of the two or more port groups. In an eleventh aspect, alone or in combination with one or more of the ninth or tenth aspects, the combined CBSR comprises a plurality of indices associated with the two or more port groups, and a plurality of differential transmission power restriction values corresponding to a plurality of spatial bases of each of the two or more port groups. In a twelfth aspect, alone or in combination with the eleventh aspect, the plurality of indices are indicated using a bitmap.

In a thirteenth aspect, alone or in combination with one or more of the fifth through twelfth aspects, the CSI reporting configuration comprises a differential value indicating a combined CBSR associated with a combination of two or more port groups of the plurality of port groups. In a fourteenth aspect, alone or in combination with one or more of the fifth through thirteenth aspects, the CSI reporting configuration is associated with an mTRP configuration, the CSI reporting configuration comprising an indication of at least one port group combination, wherein the indication of the at least one port group combination comprises an indication of a plurality of port group indices, each index of the plurality of port group indices corresponding to a port group of the at least one port group combination, wherein each CBSR corresponds to a port group of the at least one port group combination.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 504) performs operations associated with port groups for reporting mTRP CJT CSI.

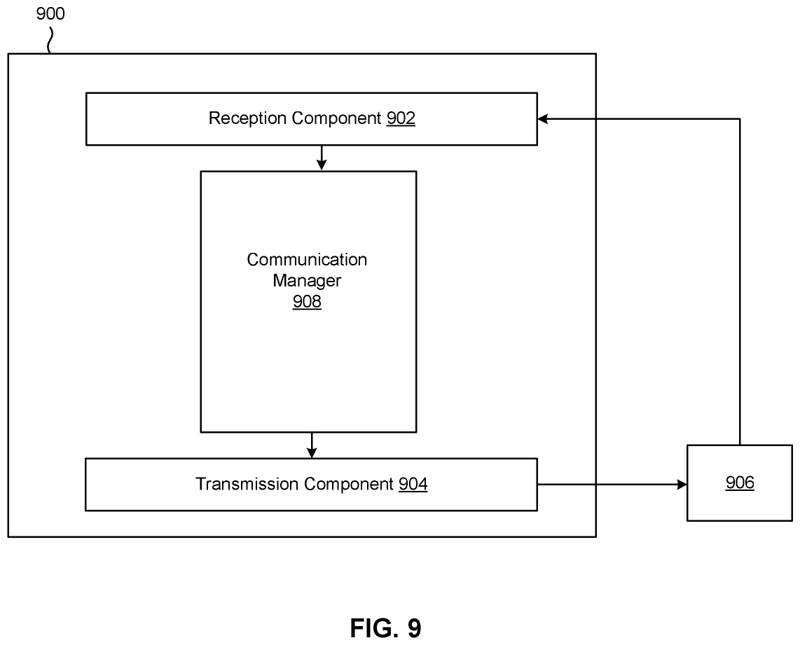

As shown in FIG. 7, in some aspects, process 700 may include transmitting a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of CBSRs associated with the multi-port CSI-RS resource, each CBSR of the plurality of CBSRs associated with a port group of the plurality of port groups (block 710). For example, the network node (e.g., using communication manager 908 and/or transmission component 904, depicted in FIG. 9) may transmit a CSI reporting configuration indicating a plurality of port groups, each port group of the plurality of port groups comprising one or more ports of a plurality of ports associated with a multi-port CSI-RS resource for reporting mTRP CJT CSI, and indicating a plurality of CBSRs associated with the multi-port CSI-RS resource, each CBSR of the plurality of CBSRs associated with a port group of the plurality of port groups, as described above, for example, with reference to FIG. 5.

As further shown in FIG. 7, in some aspects, process 700 may include transmitting a multi-port CSI-RS communication (block 720). For example, the network node (e.g., using communication manager 908 and/or transmission component 904, depicted in FIG. 9) may transmit a multi-port CSI-RS communication, as described above, for example, with reference to FIG. 5.

As further shown in FIG. 7, in some aspects, process 700 may include receiving an mTRP CJT CSI report based at least in part on the CSI reporting configuration and the multi-port CSI-RS communication (block 730). For example, the network node (e.g., using communication manager 908 and/or reception component 902, depicted in FIG. 9) may receive an mTRP CJT CSI report based at least in part on the CSI reporting configuration and the multi-port CSI-RS communication, as described above, for example, with reference to FIG. 5.

Process 700 may include additional aspects, such as any single aspect or any combination of aspects described below and/or in connection with one or more other processes described elsewhere herein.

In a first aspect, the mTRP CJT CSI report corresponds to one or more mTRP CJT PMIs associated with a selected one or more port groups of the plurality of port groups. In a second aspect, alone or in combination with the first aspect, the selected one or more port groups comprises only one port group, and wherein an mTRP CJT PMI, of the one or more mTRP CJT PMIs, associated with the only one port group satisfies a CBSR associated with the only one port group. In a third aspect, alone or in combination with one or more of the first and second aspects, the selected one or more port groups comprises a plurality of port groups, and wherein an mTRP CJT PMI, of the one or more mTRP CJT PMIs, associated with a port group of the plurality of port groups satisfies a combined CBSR associated with a combination of port groups that includes the port group.

In a fourth aspect, alone or in combination with one or more of the first through third aspects, each port group of the plurality of port groups corresponds to one TRP of a plurality of TRPs associated with multi-port CSI-RS communication. In a fifth aspect, alone or in combination with the one or more of the first through fourth aspects, the plurality of CBSRs are associated with a first selectable option and a second selectable option, the first selectable option corresponding to a single-TRP configuration and the second selectable option corresponding to an mTRP configuration. In a sixth aspect, alone or in combination with the fifth aspect, the first selectable option indicates the plurality of CBSRs, wherein each CBSR of the plurality of CBSRs is associated with one port group of the plurality of port groups. In a seventh aspect, alone or in combination with the sixth aspect, a CBSR of the plurality of CBSRs comprises a Type II codebook CBSR comprising at least one restriction, wherein the at least one restriction comprises an indication of a spatial basis group containing one or more spatial bases having shared oversampling offsets, and a respective indication of a maximum transmission power of each spatial basis of the spatial basis group.

In an eighth aspect, alone or in combination with one or more of the fifth through seventh aspects, the second selectable option indicates a combined CBSR associated with a combination of two or more port groups of the plurality of port groups. In a ninth aspect, alone or in combination with the eighth aspect, the combined CBSR comprises the plurality of CBSRs, wherein each CBSR of the plurality of CBSRs is associated with one port group of the two or more port groups. In a tenth aspect, alone or in combination with one or more of the eighth through ninth aspects, the combined CBSR comprises a plurality of indices associated with the two or more port groups, and a plurality of differential transmission power restriction values corresponding to a plurality of spatial bases of each of the two or more port groups. In an eleventh aspect, alone or in combination with the tenth aspect, the plurality of indices are indicated using a bitmap.

In a twelfth aspect, alone or in combination with one or more of the fifth through eleventh aspects, the CSI reporting configuration comprises a differential value indicating a combined CBSR associated with a combination of two or more port groups of the plurality of port groups. In a thirteenth aspect, alone or in combination with one or more of the fifth through twelfth aspects, the CSI reporting configuration is associated with an mTRP configuration, the CSI reporting configuration comprising an indication of at least one port group combination, wherein the indication of the at least one port group combination comprises an indication of a plurality of port group indices, each index of the plurality of port group indices corresponding to a port group of the at least one port group combination, wherein each CBSR corresponds to a port group of the at least one port group combination.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a communication manager 808. The communication manager 808 may include one or more of a determination component 810, or a selection component 812, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive a CSI reporting configuration indicating a plurality of port groups, each port group of the plurality of port groups comprising one or more ports of a plurality of ports associated with a multi-port CSI-RS resource for reporting mTRP CJT CSI. The reception component 802 may receive a multi-port CSI-RS communication. The transmission component 804 may transmit an mTRP CJT CSI report based at least in part on the CSI reporting configuration and the multi-port CSI-RS communication.

The communication manager 808 and/or the determination component 810 may determine channel state information based at least in part on the multi-port CSI-RS communication. In some aspects, the communication manager 808 may include one or more antennas, a modem, a controller/processor, a memory, or a combination thereof, of the UE described in connection with FIG. 2. In some aspects, the communication manager 808 may be, be similar to, include, or be included in, the communication manager 140 depicted in FIGS. 1 and 2. In some aspects, the communication manager 808 may include the reception component 802 and/or the transmission component 804. In some aspects, the determination component 810 may include one or more antennas, a modem, a controller/processor, a memory, or a combination thereof, of the UE described in connection with FIG. 2. In some aspects, the determination component 810 may include the reception component 802 and/or the transmission component 804.

The communication manager 808 and/or the selection component 812 may select one or more port groups of the plurality of port groups. In some aspects, the selection component 812 may include one or more antennas, a modem, a controller/processor, a memory, or a combination thereof, of the UE described in connection with FIG. 2. In some aspects, the selection component 812 may include the reception component 802 and/or the transmission component 804.

The determination component 810 may determine one or more mTRP CJT PMIs associated with the one or more port groups. The reception component 802 may receive a CBSR configuration associated with the multi-port CSI-RS resource. The selection component 812 may select only one port group of the plurality of port groups for reporting, wherein the first selectable option is selected based at least in part on the selection of the only one port group.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a communication manager 150.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 908 and/or the transmission component 904 may transmit a CSI reporting configuration indicating a plurality of port groups, each port group of the plurality of port groups comprising one or more ports of a plurality of ports associated with a multi-port CSI-RS resource for reporting mTRP CJT CSI. The transmission component 904 may transmit a multi-port CSI-RS communication. The reception component 902 may receive an mTRP CJT CSI report based at least in part on the CSI reporting configuration and the multi-port CSI-RS communication.

In some aspects, the communication manager 908 may include one or more antennas, a modem, a controller/processor, a memory, or a combination thereof, of the base station described in connection with FIG. 2. In some aspects, the communication manager 908 may be, be similar to, include, or be included in, the communication manager 150 depicted in FIGS. 1 and 2. In some aspects, the communication manager 908 may include the reception component 902 and/or the transmission component 904.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving a channel state information (CSI) reporting configuration indicating a plurality of port groups, each port group of the plurality of port groups comprising one or more ports of a plurality of ports associated with a multi-port channel state information-reference signal (CSI-RS) resource for reporting multiple transmission reception point (mTRP) coherent joint transmission (CJT) CSI, and indicating a plurality of codebook subset restrictions (CBSRs) associated with the multi-port CSI-RS resource, each CBSR of the plurality of CBSRs associated with a port group of the plurality of port groups; receiving a multi-port CSI-RS communication; and transmitting an mTRP CJT CSI report based at least in part on the CSI reporting configuration and the multi-port CSI-RS communication.

Aspect 2: The method of Aspect 1, further comprising: determining channel state information based at least in part on the multi-port CSI-RS communication; selecting one or more port groups of the plurality of port groups; and determining one or more mTRP CJT precoding matrix indicators (PMIs) associated with the one or more port groups based on the plurality of CBSRs.

Aspect 3: The method of Aspect 2, wherein selecting one or more port groups comprises selecting only one port group, and wherein an mTRP CJT PMI, of the one or more mTRP CJT PMIs, associated with the only one port group satisfies a CBSR, of the plurality of CBSRs, associated with the only one port group.

Aspect 4: The method of either of Aspects 2 or 3, wherein selecting one or more port groups comprises selecting a plurality of port groups, and wherein an mTRP CJT PMI, of the one or more mTRP CJT PMIs, associated with a port group of the plurality of port groups satisfies a combined CBSR associated with a combination of port groups that includes the port group.

Aspect 5: The method of any of Aspects 1-4, wherein each port group of the plurality of port groups corresponds to one transmission reception point (TRP) of a plurality of TRPs associated with multi-port CSI-RS communication.

Aspect 6: The method of Aspect 1, wherein the plurality of CBSRs are associated with a first selectable option and a second selectable option, the first selectable option corresponding to a single-transmission reception point (TRP) configuration and the second selectable option corresponding to an mTRP configuration.

Aspect 7: The method of Aspect 6, wherein the first selectable option indicates a plurality of CBSRs, wherein each CBSR of the plurality of CBSRs is associated with one port group of the plurality of port groups.

Aspect 8: The method of Aspect 7, wherein a CBSR of the plurality of CBSRs comprises a Type II codebook CBSR comprising at least one restriction, wherein the at least one restriction comprises: an indication of a spatial basis group containing one or more spatial bases having shared oversampling offsets; and a respective indication of a maximum transmission power of each spatial basis of the spatial basis group.

Aspect 9: The method of any of Aspects 6-8, further comprising selecting only one port group of the plurality of port groups for reporting, wherein the first selectable option is selected based at least in part on the selection of the only one port group.

Aspect 10: The method of any of Aspects 6-9, wherein the second selectable option indicates a combined CBSR associated with a combination of two or more port groups of the plurality of port groups.

Aspect 11: The method of Aspect 10, wherein the combined CBSR comprises the plurality of CBSRs, wherein each CBSR of the plurality of CBSRs is associated with one port group of the two or more port groups.

Aspect 12: The method of either of Aspects 10 or 11, wherein the combined CBSR comprises: a plurality of indices associated with the two or more port groups; and a plurality of differential transmission power restriction values corresponding to a plurality of spatial bases of each of the two or more port groups.

Aspect 13: The method of Aspect 12, wherein the plurality of indices are indicated using a bitmap.

Aspect 14: The method of any of Aspects 1-14, wherein the CSI reporting configuration comprises a differential value indicating a combined CBSR associated with a combination of two or more port groups of the plurality of port groups.

Aspect 15: The method of any of Aspects 1-14, wherein the CSI reporting configuration is associated with an mTRP configuration, the CSI reporting configuration comprising an indication of at least one port group combination, wherein the indication of the at least one port group combination comprises: an indication of a plurality of port group indices, each index of the plurality of port group indices corresponding to a port group of the at least one port group combination, wherein each CBSR corresponds to a port group of the at least one port group combination.

Aspect 16: A method of wireless communication performed by a network node, comprising: transmitting a channel state information (CSI) reporting configuration indicating a plurality of port groups, each port group of the plurality of port groups comprising one or more ports of a plurality of ports associated with a multi-port channel state information-reference signal (CSI-RS) resource for reporting multiple transmission reception point (mTRP) coherent joint transmission (CJT) CSI, and indicating a plurality of codebook subset restrictions (CBSRs) associated with the multi-port CSI-RS resource, each CBSR of the plurality of CBSRs associated with a port group of the plurality of port groups; transmitting a multi-port CSI-RS communication; and receiving an mTRP CJT CSI report based at least in part on the CSI reporting configuration and the multi-port CSI-RS communication.

Aspect 17: The method of Aspect 16, wherein the mTRP CJT CSI report corresponds to one or more mTRP CJT precoding matrix indicators (PMIs) associated with a selected one or more port groups of the plurality of port groups based on the plurality of CBSRs.

Aspect 18: The method of Aspect 17, wherein the selected one or more port groups comprises only one port group, and wherein an mTRP CJT PMI, of the one or more mTRP CJT PMIs, associated with the only one port group satisfies a CBSR, of the plurality of CBSRs, associated with the only one port group.

Aspect 19: The method of either of Aspects 17 or 18, wherein the selected one or more port groups comprises a plurality of port groups, and wherein an mTRP CJT PMI, of the one or more mTRP CJT PMIs, associated with a port group of the plurality of port groups satisfies a combined CBSR associated with a combination of port groups that includes the port group.

Aspect 20: The method of any of Aspects 16-19, wherein each port group of the plurality of port groups corresponds to one transmission reception point (TRP) of a plurality of TRPs associated with multi-port CSI-RS communication.

Aspect 21: The method of Aspect 16, wherein the plurality of CBSRs are associated with a first selectable option and a second selectable option, the first selectable option corresponding to a single-transmission reception point (TRP) configuration and the second selectable option corresponding to an mTRP configuration.

Aspect 22: The method of Aspect 21, wherein the first selectable option indicates a plurality of CBSRs, wherein each CBSR of the plurality of CBSRs is associated with one port group of the plurality of port groups.

Aspect 23: The method of Aspect 22, wherein a CBSR of the plurality of CBSRs comprises a Type II codebook CBSR comprising at least one restriction, wherein the at least one restriction comprises: an indication of a spatial basis group containing one or more spatial bases having shared oversampling offsets; and a respective indication of a maximum transmission power of each spatial basis of the spatial basis group.

Aspect 24: The method of any of Aspects 21-23, wherein the second selectable option indicates a combined CBSR associated with a combination of two or more port groups of the plurality of port groups.

Aspect 25: The method of Aspect 24, wherein the combined CBSR comprises a plurality of CBSRs, wherein each CBSR of the plurality of CBSRs is associated with one port group of the two or more port groups.

Aspect 26: The method of either of Aspects 24 or 25, wherein the combined CBSR comprises: a plurality of indices associated with the two or more port groups; and a plurality of differential transmission power restriction values corresponding to a plurality of spatial bases of each of the two or more port groups.

Aspect 27: The method of Aspect 26, wherein the plurality of indices are indicated using a bitmap.

Aspect 28: The method of any of Aspects 21-27, wherein the CSI reporting configuration comprises a differential value indicating a combined CBSR associated with a combination of two or more port groups of the plurality of port groups.

Aspect 29: The method of any of Aspects 21-28, wherein the CSI reporting configuration is associated with an mTRP configuration, the CSI reporting configuration comprising an indication of at least one port group combination, wherein the indication of the at least one port group combination comprises: an indication of a plurality of port group indices, each index of the plurality of port group indices corresponding to a port group of the at least one port group combination, wherein each CBSR corresponds to a port group of the at least one port group combination.

Aspect 30: An apparatus for wireless communication at a device, comprising a processor; memory coupled with the processor; and instructions stored in the memory and executable by the processor to cause the apparatus to perform the method of one or more of Aspects 1-15.

Aspect 31: A device for wireless communication, comprising a memory and one or more processors coupled to the memory, the one or more processors configured to perform the method of one or more of Aspects 1-15.

Aspect 32: An apparatus for wireless communication, comprising at least one means for performing the method of one or more of Aspects 1-15.

Aspect 33: A non-transitory computer-readable medium storing code for wireless communication, the code comprising instructions executable by a processor to perform the method of one or more of Aspects 1-15.

Aspect 34: A non-transitory computer-readable medium storing a set of instructions for wireless communication, the set of instructions comprising one or more instructions that, when executed by one or more processors of a device, cause the device to perform the method of one or more of Aspects 1-15.

Aspect 35: An apparatus for wireless communication at a device, comprising a processor; memory coupled with the processor; and instructions stored in the memory and executable by the processor to cause the apparatus to perform the method of one or more of Aspects 16-29.

Aspect 36: A device for wireless communication, comprising a memory and one or more processors coupled to the memory, the one or more processors configured to perform the method of one or more of Aspects 16-29.

Aspect 37: An apparatus for wireless communication, comprising at least one means for performing the method of one or more of Aspects 16-29.

Aspect 38: A non-transitory computer-readable medium storing code for wireless communication, the code comprising instructions executable by a processor to perform the method of one or more of Aspects 16-29.

Aspect 39: A non-transitory computer-readable medium storing a set of instructions for wireless communication, the set of instructions comprising one or more instructions that, when executed by one or more processors of a device, cause the device to perform the method of one or more of Aspects 16-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a channel state information (CSI) reporting configuration indicating a plurality of port groups, each port group of the plurality of port groups comprising one or more ports of a plurality of ports associated with a multi-port channel state information-reference signal (CSI-RS) resource for reporting multiple transmission reception point (mTRP) coherent joint transmission (CJT) CSI, and indicating a plurality of codebook subset restrictions (CBSRs) associated with the multi-port CSI-RS resource, each CBSR of the plurality of CBSRs associated with a port group of the plurality of port groups;
receive a multi-port CSI-RS communication; and
transmit an mTRP CJT CSI report based at least in part on the CSI reporting configuration and the multi-port CSI-RS communication.

2. The UE of claim 1, wherein the one or more processors are further configured to:
determine channel state information based at least in part on the multi-port CS-IRS communication;
select one or more port groups of the plurality of port groups; and
determine one or more mTRP CJT precoding matrix indicators (PMIs) associated with the one or more port groups based on the plurality of CBSRs.

3. The UE of claim 2, wherein the one or more processors, to select one or more port groups, are configured to select only one port group, and wherein an mTRP CJT PMI, of the one or more mTRP CJT PMIs, associated with the only one port group satisfies a CBSR, of the plurality of CBSRs, associated with the only one port group.

4. The UE of claim 2, wherein the one or more processors, to select one or more port groups, are configured to select a plurality of port groups, and wherein an mTRP CJT PMI, of the one or more mTRP CJT PMIs, associated with a port group of the plurality of port groups satisfies a combined CBSRassociated with a combination of port groups that includes the port group.

5. The UE of claim 1, wherein each port group of the plurality of port groups corresponds to one transmission reception point (TRP) of a plurality of TRPs associated with multi-port CSI-RS communication.

6. The UE of claim 1, wherein the plurality of CBSRs are associated with a first selectable option and a second selectable option, the first selectable option corresponding to a single-transmission reception point (TRP) configuration and the second selectable option corresponding to an mTRP configuration.

7. The UE of claim 6, wherein the first selectable option indicates a plurality of CBSRs, wherein each CBSR of the plurality of CBSRs is associated with one port group of the plurality of port groups.

8. The UE of claim 7, wherein a CBSR of the plurality of CBSRs comprises a Type II codebook CBSR comprising at least one restriction, wherein the at least one restriction comprises:
an indication of a spatial basis group containing one or more spatial bases having shared oversampling offsets; and
a respective indication of a maximum transmission power of each spatial basis of the spatial basis group.

9. The UE of claim 6, wherein the one or more processors are further configured to select only one port group of the plurality of port groups for reporting, wherein the first selectable option is selected based at least in part on the selection of the only one port group.

10. The UE of claim 6, wherein the second selectable option indicates a combined CBSR associated with a combination of two or more port groups of the plurality of port groups.

11. The UE of claim 10, wherein the combined CBSR comprises the plurality of CBSRs, wherein each CBSR of the plurality of CBSRs is associated with one port group of the two or more port groups.

12. The UE of claim 10, wherein the combined CBSR comprises:
a plurality of indices associated with the two or more port groups; and
a plurality of differential transmission power restriction values corresponding to a plurality of spatial bases of each of the two or more port groups.

13. The UE of claim 12, wherein the plurality of indices are indicated using a bitmap.

14. The UE of claim 1, wherein the CSI reporting configuration comprises a differential value indicating a combined CBSR associated with a combination of two or more port groups of the plurality of port groups.

15. The UE of claim 1, wherein the CSI reporting configuration is associated with an mTRP configuration, the CSI reporting configuration comprising an indication of at least one port group combination, wherein the indication of the at least one port group combination comprises
an indication of a plurality of port group indices, each index of the plurality of port group indices corresponding to a port group of the at least one port group combination, wherein
each CBSR corresponds to a port group of the at least one port group combination.

16. A network node for wireless communication, comprising:
a memory; and
one or more processors, coupled to the memory, configured to:
transmit a channel state information (CSI) reporting configuration indicating a plurality of port groups, each port group of the plurality of port groups comprising one or more ports of a plurality of ports associated with a multi-port channel state information-reference signal (CSI-RS) resource for reporting multiple transmission reception point (mTRP) coherent joint transmission (CJT) CSI, and indicating a plurality of codebook subset restrictions (CBSRs) associated with the multi-port CSI-RS resources, each CBSR of the plurality of CBSRs associated with a port group of the plurality of port groups;
transmit a multi-port CSI-RS communication; and
receive an mTRP CJT CSI report based at least in part on the CSI reporting configuration and the multi-port CSI-RS communication.

17. The network node of claim 16, wherein the mTRP CJT CSI report corresponds to one or more mTRP CJT precoding matrix indicators (PMIs) associated with a selected one or more port groups of the plurality of port groups based on the plurality of CBSRs.

18. The network node of claim 17, wherein the selected one or more port groups comprises only one port group, and wherein an mTRP CJT PMI, of the one or more mTRP CJT PMIs, associated with the only one port group satisfies a codebook subset restriction, of the plurality of CBSRs, associated with the only one port group.

19. The network node of claim 17, wherein the selected one or more port groups comprises a plurality of port groups, and wherein an mTRP CJT PMI, of the one or more mTRP CJT PMIs, associated with a port group of the plurality of port groups satisfies a combined CBSR associated with a combination of port groups that includes the port group.

20. The network node of claim 16, wherein the plurality of CBSRs are associated with a first selectable option and a second selectable option, the first selectable option corresponding to a single-transmission reception point (TRP) configuration and the second selectable option corresponding to an mTRP configuration.

21. The network node of claim 20, wherein the first selectable option indicates the plurality of CBSRs, wherein each CBSR of the plurality of CBSRs is associated with one port group of the plurality of port groups.

22. The network node of claim 21, wherein a CBSR of the plurality of CBSRs comprises a Type II codebook CBSR comprising at least one restriction, wherein the at least one restriction comprises:
an indication of a spatial basis group containing one or more spatial bases having shared oversampling offsets; and
a respective indication of a maximum transmission power of each spatial basis of the spatial basis group.

23. The network node of claim 22, wherein the second selectable option indicates a combined CBSR associated with a combination of two or more port groups of the plurality of port groups, wherein the combined CBSR comprises a plurality of CBSRs, wherein each CBSR of the plurality of CBSRs is associated with one port group of the two or more port groups.

24. The network node of claim 23, wherein the combined CBSR comprises:
a plurality of indices associated with the two or more port groups; and
a plurality of differential transmission power restriction values corresponding to a plurality of spatial bases of each of the two or more port groups.

25. The network node of claim 16, wherein the CSI reporting configuration comprises a differential value indicating a combined CBSR associated with a combination of two or more port groups of the plurality of port groups.

26. The network node of claim 16, wherein the CSI reporting configuration is associated with an mTRP configuration, the CSI reporting configuration comprising an indication of at least one port group combination, wherein the indication of the at least one port group combination comprises:
an indication of a plurality of port group indices, each index of the plurality of port group indices corresponding to a port group of the at least one port group combination, wherein
each CBSR corresponds to a port group of the at least one port group combination.

27. A method of wireless communication performed by a user equipment (UE), comprising:
receiving a channel state information (CSI) reporting configuration indicating a plurality of port groups, each port group of the plurality of port groups comprising one or more ports of a plurality of ports associated with a multi-port channel state information-reference signal (CSI-RS) resource for reporting multiple transmission reception point (mTRP) coherent joint transmission (CJT) CSI, and indicating a plurality of codebook subset restrictions (CBSRs) associated with the multi-port CSI-RS resource, each CBSR of the plurality of CBSRs associated with a port group of the plurality of port groups;
receiving a multi-port CSI-RS communication; and
transmitting an mTRP CJT CSI report based at least in part on the CSI reporting configuration and the multi-port CSI-RS communication.

28. The method of claim 27, further comprising:
determining channel state information based at least in part on the multi-port CSI-RS communication;
selecting one or more port groups of the plurality of port groups; and
determining one or more mTRP CJT precoding matrix indicators (PMIs) associated with the one or more port groups based on the plurality of CBSRs.

29. A method of wireless communication performed by a network node, comprising:
transmitting a channel state information (CSI) reporting configuration indicating a plurality of port groups, each port group of the plurality of port groups comprising one or more ports of a plurality of ports associated with a multi-port channel state information-reference signal (CSI-RS) resource for reporting multiple transmission reception point (mTRP) coherent joint transmission (CJT) CSI, and indicating a plurality of codebook subset restrictions (CBSRs) associated with the multi-port CSI-RS resources, each CBSR of the plurality of CBSRs associated with a port group of the plurality of port groups;
transmitting a multi-port CSI-RS communication; and
receiving an mTRP CJT CSI report based at least in part on the CSI reporting configuration and the multi-port CSI-RS communication.

30. The method of claim 29, wherein the mTRP CJT CSI report corresponds to one or more mTRP CJT precoding matrix indicators (PMIs) associated with a selected one or more port groups of the plurality of port groups based on the plurality of CBSRs.
